(19) United States
(12) Patent Application Publication
(10) Pub. No.: US 2017/0090363 A1
(43) Pub. Date: Mar. 30, 2017

(54) FIXING DEVICE AND IMAGE FORMING APPARATUS

(71) Applicant: KYOCERA Document Solutions Inc., Osaka (JP)

(72) Inventors: Takefumi YOTSUTSUJI, Osaka-shi (JP); Yoshihiro YAMAGISHI, Osaka-shi (JP); Takashi EIKI, Osaka-shi (JP); Kotatsu KAWAGUCHI, Osaka-shi (JP)

(73) Assignee: KYOCERA Document Solutions Inc., Osaka (JP)

(21) Appl. No.: 15/266,242

(22) Filed: Sep. 15, 2016

(30) Foreign Application Priority Data
Sep. 28, 2015 (JP) 2015-189818

(51) Int. Cl. G03G 15/20

(52) U.S. Cl. CPC G03G 15/2039

(57) ABSTRACT

A fixing device includes a heating body heated by a heat source, a pressuring body, a conversion temperature detecting part, a substrate temperature detecting part, a lens temperature detecting part, a conversion temperature correcting part and a controller. The conversion temperature detecting part has an infrared ray detecting element mounted to a substrate detecting an infrared ray from the heating body and a lens optically focusing the infrared ray onto the infrared ray detecting element. The conversion temperature detecting part detects conversion temperature of surface temperature of the heating body with detection result of the infrared ray detecting element. The substrate temperature detecting part detects substrate temperature. The lens temperature detecting part detects lens temperature. The conversion temperature correcting part corrects the conversion temperature with the substrate temperature and the lens temperature. The controller controls the heat source so that the conversion temperature becomes predetermined fixing control temperature.

### INCORPORATION BY REFERENCE

This application is based on and claims the benefit of priority from Japanese Patent application No. 2015-189818 filed on Sep. 28, 2015, the entire contents of which are incorporated herein by reference.

### BACKGROUND

The present disclosure relates to a fixing device for fixing a toner image to a recording medium and an image forming apparatus including the fixing device.

An image forming apparatus of an electrographic manner, such as a copying machine or a printer, includes a fixing device for fixing a toner image to a recording medium, such as a sheet.

For example, there is known a fixing device in which a fixing roller (a heating body) coming into direct contact with a pressing roller (a pressuring body) to thereby form a fixing nip is configured as a heating member heated by an electromagnetic induction heating means. In this fixing device, the fixing roller is provided with a heating layer heated by the electromagnetic induction heating means, and then, the fixing roller is directly heated and a thermopile (an infrared ray detecting element) is provided integrally with a coil guide. Incidentally, in the coil guide, a cylindrical part in which a through hole for mounting has been formed is provided, and then, the thermopile is fitted into the hole of the cylindrical part and the hole is closed.

The fixing device configured to detect temperature of the heating body by using the thermopile may include a lens for optically focusing an infrared ray onto the thermopile.

In the fixing device including the thermopile (the infrared detecting element), if overshoot or the like occurs at the time of printing or deactivation in an image forming apparatus, the lens may be heated by a convection heat from the heating body. As a result, there may be a case in which the thermopile redundantly detects a radiant heat from the lens and mistakenly detects temperature of the heating body. Incidentally, in a configuration in which temperature rise of the lens is detected by an environmental temperature sensor or the like and detected temperature by the thermopile is decreased in accordance with a degree of the rise, a time lag occurs in temperature detection in the environmental temperature sensor with respect to a rapid temperature change of the lens. As a result, even if such a rapid temperature change occurs in the lens, the detected temperature by the thermopile cannot be decreased and a temperature difference between actual temperature of the heating body and the detection temperature at the thermopile occurs.

Thus, if the heat of the heating body cannot be appropriately detected, there is a possibility that high temperature of the heating body cannot be detected and the heating body is overheated, and moreover, there is also a possibility of firing.

### SUMMARY

In accordance with an embodiment of the present disclosure, a fixing device includes a heating body, a pressuring body, a conversion temperature detecting part, a substrate temperature detecting part, a lens temperature detecting part, a conversion temperature correcting part and a controller. A surface of the heating body is heated by a heat source. The pressuring body is brought into pressure contact with the heating body to form a fixing nip. The conversion temperature detecting part is arranged with respect to the heating body in a noncontact manner. The conversion temperature detecting part is provided with an infrared ray detecting element detecting an infrared ray radiated from the surface of the heating body, a substrate to which the infrared ray detecting element is mounted and a lens optically focusing the infrared ray onto the infrared ray detecting element. The conversion temperature detecting part is configured to detect conversion temperature corresponding to surface temperature of the heating body on the basis of a detection result of the infrared ray detecting element. The substrate temperature detecting part detects substrate temperature value of the substrate. The lens temperature detecting part detects lens temperature value of the lens. The conversion temperature correcting part corrects the conversion temperature on the basis of the substrate temperature value and the lens temperature value. The controller is configured to control the heat source so that the conversion temperature becomes predetermined fixing control temperature.

In accordance with an embodiment of the present disclosure, an image forming apparatus includes the above-mentioned fixing part.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a sectional view schematically showing a printer according to an embodiment of the present disclosure.

FIG. 2 is a sectional view showing a fixing device according to the embodiment of the present disclosure.

FIG. 3 is a sectional view showing a temperature detecting part of the fixing device according to the embodiment of the present disclosure.

FIG. 4 is a block diagram showing a control system of the fixing device according to the embodiment of the present disclosure.

FIG. 5 is a graph showing a relationship between a difference between lens temperature and substrate temperature and a difference between actually measured temperature of a heating belt and conversion temperature at a conversion temperature detecting part, in the fixing device according to the embodiment of the present disclosure.

FIG. 6 is a graph showing a relationship between an elapsed time from activation of a printer including the fixing device and the lens temperature detected by a lens temperature detecting part and actual temperature of the lens, in the fixing device according to the embodiment of the present disclosure.

FIG. 7 is a graph showing a relationship between the elapsed time from activation of the printer including the fixing device and an electromotive force detected by a thermopile, in the fixing device according to the embodiment of the present disclosure.

### DETAILED DESCRIPTION

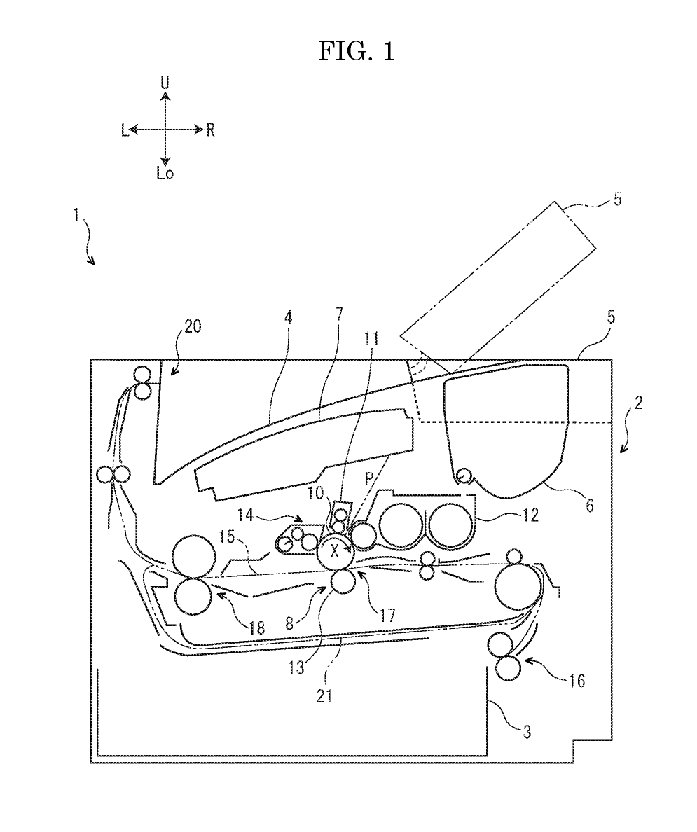

First, with reference to FIG. 1, the entire structure of a printer 1 (an image forming apparatus) will be described. Arrows Fr, Rr, L, R, U and Lo in each of the drawings respectively indicate a front side, a rear side, a left side, a right side, an upper side and a lower side of the printer 1.

The printer 1 includes a box-like formed printer main body 2. In a lower part of the printer main body 2, a sheet feeding cartridge 3 storing sheets (recording mediums) is installed. In an upper face of the printer main body 2, an ejected sheet tray 4 is formed. In the upper face of the printer main body 2, an upper cover 5 is openably/closably attached at a lateral side of the ejected sheet tray 4. Below the upper cover 5, a toner container 6 is installed.

In an upper part inside the printer main body 2, an exposure device 7 composed of a laser scanning unit (LSU) is located below the ejected sheet tray 4. Below the exposure device 7, an image forming part 8 is arranged. In the image forming part 8, a photosensitive drum 10 as an image carrier is rotatably arranged. Around the photosensitive drum 10, a charging device 11, a development device 12, a transfer roller 13 and a cleaning device 14 are located along a rotating direction (refer to an arrow X in FIG. 1) of the photosensitive drum 10.

Inside the printer main body 2, a conveying path 15 for the sheet is arranged. At an upstream end of the conveying path 15, a sheet feeding part 16 is positioned. At an intermediate stream part of the conveying path 15, a transferring part 17 composed of the photosensitive drum 10 and transfer roller 13 is positioned. At a downstream part of the conveying path 15, a fixing device 18 is positioned. At a downstream end of the conveying path 15, a sheet ejecting part 20 is positioned. Below the conveying path 15, an inversion path 21 for duplex printing is arranged.

Next, image forming operation of the printer 1 including such a configuration will be described.

When the power is supplied to the color printer 1, various parameters are initialized and initial determination, such as temperature determination of the fixing device 18, is carried out. Subsequently, in the printer 1, when image data is inputted and a printing start is directed from a computer or the like connected with the printer 1, image forming operation is carried out as follows.

First, the surface of the photosensitive drum 10 is electrically charged by the charging device 11. Then, photographic exposure corresponding to the image data is carried out to the photosensitive drum 10 by a laser light (refer to a two-dot chain line P in FIG. 1) from the exposure device 7, thereby forming an electrostatic latent image on the surface of the photosensitive drum 10. The electrostatic latent image is developed to a toner image with a toner by the development device 12.

On the other hand, the sheet picked up from the sheet feeding cartridge 3 by the sheet feeding part 16 is conveyed to the transferring part 17 in a suitable timing for the above-mentioned image forming operation. In the transferring part 17, the toner image on the photosensitive drum 10 is transferred onto the sheet. The sheet with the transferred toner image is conveyed to a downstream side in the conveying path 15 to go into the fixing device 18. In the fixing device 18, the toner image is fixed on the sheet. The sheet with the fixed toner image is ejected from the sheet ejecting part 20 to the sheet ejected tray 4. Incidentally, the toner remained on the photosensitive drum 10 is collected by the cleaning device 14.

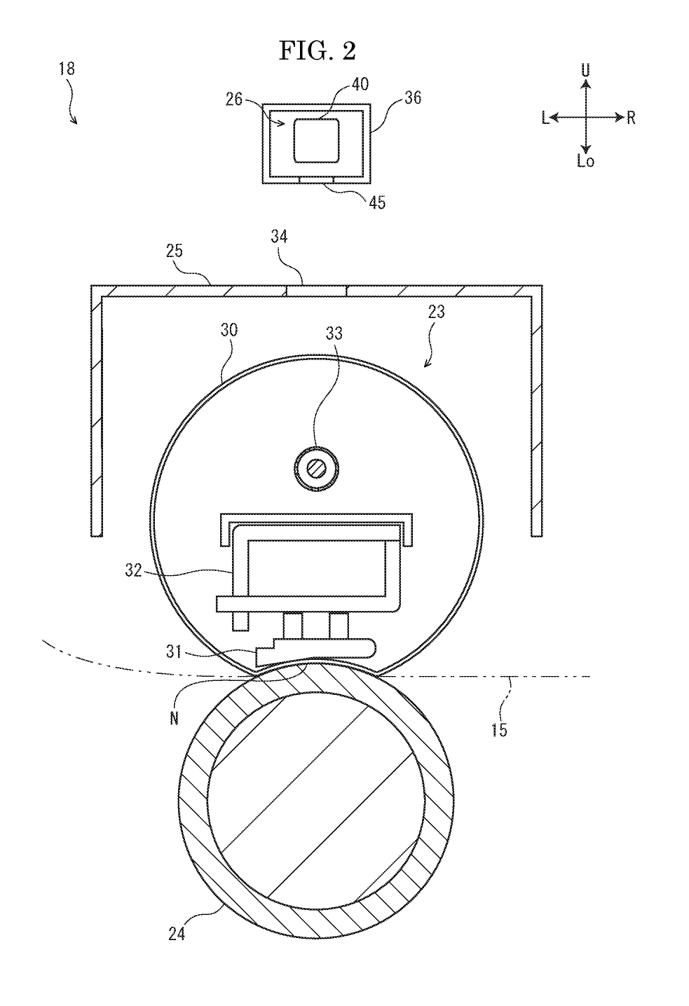

Next, the fixing device 18 will be described with reference to FIG. 2 to FIG. 7.

As shown in FIG. 2 and other figures, the fixing device 18 includes a heating body 23 and a pressuring body 24 respectively disposed at an upper side and a lower side across the conveying path 15. Also, the fixing device 18 includes a heat interrupting member 25 above the heating body 23 and includes a conversion temperature detecting part 26 detecting conversion temperature equivalent to surface temperature of the heating body 23.

The heating body 23 includes a fixing belt 30 formed in a roughly cylindrical shape, a pressing member 31 disposed along a lower side of an inner circumference face of the fixing belt 30, a supporting member 32 disposed above the pressing member 31 inside of the fixing belt 30 and a heat source 33 disposed above the supporting member 32 inside of the fixing belt 30.

The fixing belt 30 has an elongated shape in a sheet width direction (forward and backward directions) being orthogonal to (crossing) a sheet conveyance direction (left and right directions). The fixing belt 30 is rotatably mounted with respect to a main body frame (not shown) of the fixing device 18.

The fixing belt 30 is composed of, for example, a base material layer, an elastic layer provided around the base material layer and a release layer covering the elastic layer and has elasticity. The base material layer of the fixing belt 30 is formed of, for example, nickel electric casting. The elastic layer of the fixing belt 30 is formed of, for example, a silicone rubber. The release layer of the fixing belt 30 is formed of, for example, perfluoro alkoxy alkane (PFA). Incidentally, in each of the figures, the respective layers (the base material layer, the elastic layer, the release layer) of the fixing belt 30 are represented without being distinguished from each other in particular.

The pressing member 31 has an elongated shape in the forward and backward directions. The pressing member 31 is formed of, for example, heat resistant resin, such as LCP (Liquid Crystal Polymer). The pressing member 31 is disposed so that a lower face thereof presses the lower side on the inner circumference face of the fixing belt 30 toward the lower side (the side of the pressuring body 24).

The supporting member 32 is formed in a roughly rectangular cylindrical shape elongated in the forward and backward directions. The supporting member 32 is formed of, for example, metal, such as steel special use stainless (SUS). A lower face of the supporting member 32 abuts against an upper face of the pressing member 31.

The heat source 33 has an elongated shape in the forward and backward directions and is composed of, for example, a halogen lamp, a ceramic heater or the like.

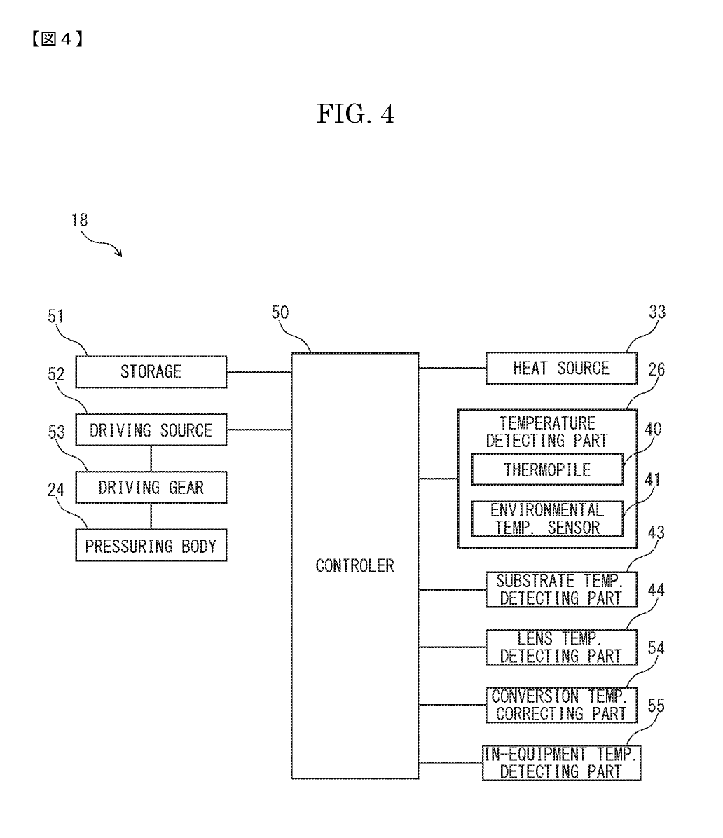

The pressuring body 24 is formed in a roughly cylindrical shape elongated in the forward and backward directions and is rotatably mounted with respect to a main body frame (not shown). The pressuring body 24 is composed of, for example, a pressuring roller or the like. When the pressuring body 24 is brought into pressure contact with the fixing belt 30, a fixing nip N is formed between the fixing belt 30 and the pressuring body 24. At a rear end of the pressuring body 24, a driving gear 53 (refer to FIG. 4) is coaxially fixed.

The pressuring body 24 is composed of, for example, a cylindrical core member, an elastic layer provided around the core member and a release layer covering the elastic layer. The core member of the pressuring body 24 is formed of, for example, metal, such as aluminum. The elastic layer of the pressuring body 24 is formed of, for example, a silicone sponge rubber. The release layer of the pressuring body 24 is formed of, for example, a PFA tube. Incidentally, in each of the figures, the respective layers (the core member, the elastic layer, the release layer) of the pressuring body 24 are represented without being distinguished from each other in particular.

The heat interrupting member 25 has an elongated shape in the forward and backward directions and is formed, for example, so as to have an inverted U-shaped cross section. The heat interrupting member 25 is disposed above the heating body 23 so as to cover the heating body 23 from an upper side. In the heat interrupting member 25, an aperture 34 for passing the infrared ray radiated from the heating body 23 to a thermopile 40 (an infrared ray detecting element) of the conversion temperature detecting part 26 is formed. Incidentally, the aperture 34 may preferably be formed at a position at which a sheet of the smallest size passes through the fixing device 18, that is, at a roughly center in the forward and backward directions (the sheet width direction).

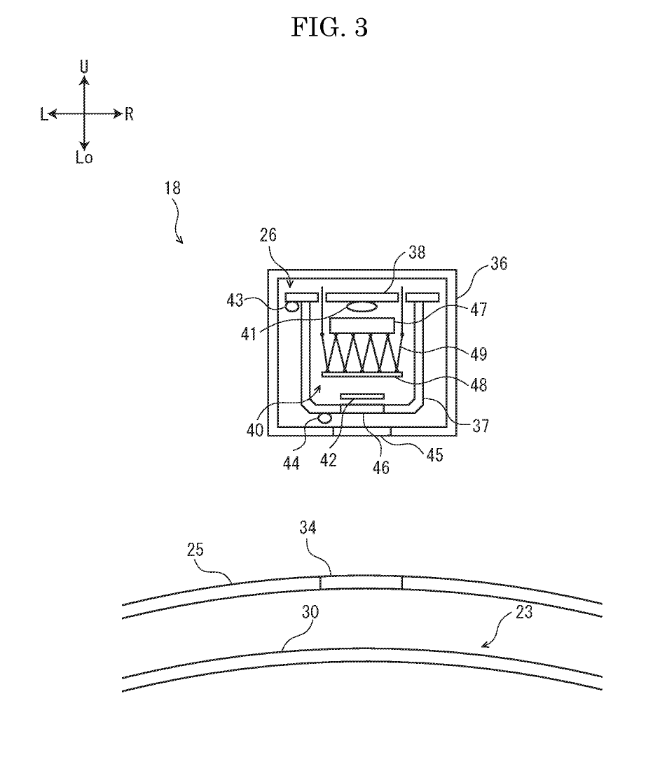

The conversion temperature detecting part 26 is mounted inside a holding member 36 and includes a casing 37, a substrate 38, the thermopile 40 (an infrared ray detecting element), an environmental temperature sensor 41 and a lens 42 (refer to FIG. 3). Further, the conversion temperature detecting part 26 includes a substrate temperature detecting part 43 and a lens temperature detecting part 44.

The holding member 36 is mounted to a main body frame (not shown) of the printer main body 2, a main body frame (not shown) of the fixing device 18 or the like above the heat interrupting member 25 and positions the conversion temperature detecting part 26 with respect to the fixing belt 30 of the heating body 23 in a noncontact manner. The holding member 36 has a roughly box-like shape and a holding member aperture 45 is formed at a roughly center of a lower face thereof.

The casing 37 has a roughly cylindrical shape and, at a roughly center of a lower face thereof, a casing aperture 46 is formed. The substrate 38 is disposed so as to close an upper end of the casing 37 and is connected to a controller 50 (refer to FIG. 4) via wiring (not shown).

The thermopile 40 is mounted to a lower face of the substrate 38 inside of the casing 37. The thermopile 40 is composed of a cold contact point 47, a hot contact point 49 and a plurality of thermocouples 49. The cold contact point 47 is provided at an upper part of the thermopile 40 and the hot contact point 48 is provided below the cold contact point 47 at a predetermined interval. Each thermocouple 49 is provided so as to electrically connect the cold contact point 47 and the hot contact point 48 to each other. To the hot contact point 48, an infrared ray entering from the casing aperture 46 via the lens 42, for example, an infrared ray from a surface of the fixing belt 30 of the heating body 23 is entered and the thermopile 40 detects surface temperature (conversion temperature) of the fixing belt 30 on the basis of an electromotive force generated by the thermocouples 49 due to a temperature difference between the cold contact point 47 and the hot contact point 48.

The environmental temperature sensor 41 is mounted to the lower face of the substrate 38 and is composed of, for example, a diode sensor of band gap type to detect temperature of the thermopile 40 itself.

The lens 42 is provided below the thermopile 40 inside of the casing 37 and is disposed so as to optically focus the infrared ray entering the casing 37 via the casing aperture 46 onto the hot contact point 48 of the thermopile 40.

The substrate temperature detecting part 43 is mounted to the substrate 38 outside the casing 37 and is composed of, for example, a thermistor of contact type or the like to detect temperature close to the substrate 38. The substrate temperature detecting part 43 is electrically connected to the substrate 38 and transmits the detected temperature close to the substrate 38 (hereinafter, referred to as “substrate temperature”) to the controller 50 via the substrate 38.

The lens temperature detecting part 44 is mounted to the vicinity of the lens 42 outside the casing 37 and is composed of, for example, a thermistor of contact type or the like to detect temperature close to the lens 42. The lens temperature detecting part 44 is electrically connected to the substrate 38 and transmits the detected temperature close to the lens 42 (hereinafter, referred to as “lens temperature”) to the controller 50 via the substrate 38.

Incidentally, the conversion temperature detecting part 26 and the holding member 36 are disposed so that the holding member aperture 45 of the holding member 36 and the casing aperture 46 of the casing 37 correspond to the aperture 34 of the heat interrupting member 25. That is, the conversion temperature detecting part 26 is disposed at a position at which the infrared ray radiated from the surface of the fixing belt 30 of the heating body 23 via the aperture 34 of the heat interrupting member 25 can be entered via the holding member aperture 45 and the casing aperture 46. The conversion temperature detecting part 26 detects the surface temperature (the conversion temperature) of the fixing belt 30 on the basis of the temperature detected by the thermopile 40 and the temperature detected by the environmental temperature sensor 41.

Next, the control system of the fixing device 18 will be described with reference to FIG. 4.

In the fixing device 18, the controller 50 composed of a CPU or the like is provided. The controller 50 is connected to storage 51 composed of a storage device, such as ROM or RAM. The controller 50 is configured to control each part of the fixing device 18 on the basis of control programs or control data stored in the storage 51. Alternatively, the control system of the fixing device 18 may utilize a controller (not shown) and a storage (not shown) constituting the control system of the printer 1 in place of the controller 50 and the storage 51.

The controller 50 is connected to a driving source 52 composed of a motor or the like and the driving source 52 is connected to the pressuring body 24 via the driving gear 53. In addition, the driving source 52 rotates the pressuring body 24 on the basis of a signal from the controller 50. If the pressuring body 24 is thus rotated, the fixing belt 30 of the pressuring body 23 brought into pressure contact with the pressuring body 24 is rotated in an opposite direction to the pressuring body 24 by following the rotation of the pressuring body 24. At this time, the fixing nip N is formed between the heating body 23 and the pressuring body 24.

The controller 50 is connected to the heat source 33. In addition, when, on the basis of the signal from the controller 50, power is supplied to the heat source 33, the heat source 33 generates heat.

The controller 50 is connected to the thermopile 40 of the conversion temperature detecting part 26. Into the thermopile 40, the infrared ray that is radiated from the surface of the fixing belt 30 of the heating body 23 is entered via the aperture 34 of the heat interrupting member 25, the holding member aperture 45 of the holding member 36 and the casing aperture 46 of the casing 37. The conversion temperature detecting part 26 detects the surface temperature (the conversion temperature) of the fixing belt 30 in accordance with the infrared ray having been entered from the fixing belt 30 as described above. Incidentally, the conversion temperature detected by the conversion temperature detecting part 26 is corrected by a conversion temperature correcting part 54. Correction by the conversion temperature correcting part 54 about the conversion temperature detected by the conversion temperature detecting part 26 will be described later.

The conversion temperature detecting part 26 outputs the detected surface temperature value of the fixing belt 30 to the controller 50. Alternatively, the conversion temperature detecting part 26 may outputs an electrical signal (the a current value or a voltage value) corresponding to the surface temperature (the conversion temperature) of the fixing belt 30 to the controller 50 and the controller 50 may calculate the surface temperature (the conversion temperature) of the fixing belt 30 on the basis of the electrical signal.

The controller 50 is capable of controlling heating of the heat source 33 on the basis of a detection result by the conversion temperature detecting part 26 as described above and setting the heating body 23 to desired fixing temperature. At this time, if the sheet with an unfixed toner image passes through the fixing nip N, the unfixed toner image is heated and fused and the toner image is fixed onto the sheet.

Next, correction of the conversion temperature that has been detected by the conversion temperature detecting part 26 will be described. The controller 50 is connected to the substrate temperature detecting part 43, the lens temperature detecting part 44 and the conversion temperature correcting part 54. Incidentally, the conversion temperature correcting part 54 may be composed of a program stored in the storage 51 and executed by the controller 50.

As described above, the conversion temperature detected by the conversion temperature detecting part 26 is transmitted to the controller 50 and further the substrate temperature detected by the substrate temperature detecting part 43 and the lens temperature detected by the lens temperature detecting part 44 are transmitted to the controller 50. Then, the conversion temperature correcting part 54 controlled by the controller 50 corrects the conversion temperature on the basis of the substrate temperature and the lens temperature.

A relationship between the conversion temperature and each of the substrate temperature and the lens temperature will be described with reference to the drawings. If an overshoot or the like occurs at the time of printing or deactivation in the printer 1, the lens 42 of the conversion temperature detecting part 26 is heated by the convection heat from the heating body 23. As a result, there may be a case in which the thermopile 40 redundantly detects the radiant heat from the lens 42 and mistakenly detects the surface temperature of the fixing belt 30 of the heating body 23. Incidentally, in a construction in which temperature rise of the lens 42 is detected by the environmental temperature sensor 41 and, in accordance with a degree of the rise, the conversion temperature of the conversion temperature detecting part is decreased, because the environmental temperature sensor 41 and the lens 42 are spaced from each other, a time lag in temperature detection in the environmental temperature sensor 41 occurs with respect to a rapid temperature change of the lens 42. As a result, even if the rapid temperature change occurs in the lens 42, the conversion temperature of the conversion temperature detecting part 26 cannot be decreased and a temperature difference occurs between actual surface temperature of the fixing belt 30 (hereinafter, referred to as “actually measured temperature”) and the conversion temperature of the conversion temperature detecting part 26.

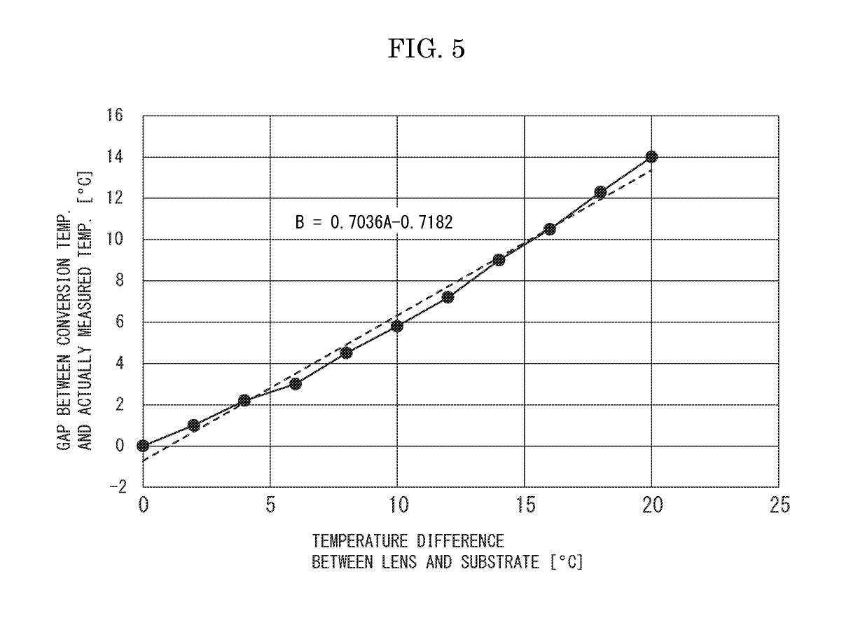

FIG. 5 is a graph showing, on the horizontal axis, a difference between the lens temperature of the lens 42 and the substrate temperature of the substrate 38 and showing, on the vertical axis, a difference between the actually temperature of the fixing belt 30 and the conversion temperature of the conversion temperature detecting part 26. As shown in FIG. 5, it is found that, as the difference between the lens temperature and the substrate temperature increases, a gap between the conversion temperature detected by the conversion temperature detecting part 26 and the actually measured temperature increases. Thereupon, the conversion temperature correcting part 54 corrects the conversion temperature of the conversion temperature detecting part so as to eliminate the difference between the lens temperature and the substrate temperature.

For example, when the difference between the lens temperature and the substrate temperature is 10 degrees centigrade, a gap of 6 degrees centigrade occurs between the conversion temperature and the actually measured temperature (refer to FIG. 5). For example, a relationship between a gap B between the conversion temperature and the actually measured temperature and a gap A between the lens temperature and the substrate temperature is expressed by a linear equation (B=0.7036×A−0.7182) using a predetermined first correction multiplier (0.7036) and a predetermined correction coefficient.

Therefore, the conversion temperature correcting part 54 is capable of calculating a correction value by subtracting the predetermined correction coefficient from a multiplication result of the difference A between the lens temperature and the substrate temperature by the predetermined first correction multiplier. Also, the conversion temperature correcting part 54 is capable of correcting the conversion temperature by subtracting the correction value from the conversion temperature of the conversion temperature detecting part 26.

Next, it will be described with respect to correction of the conversion temperature detected by the conversion temperature detecting part 26 in a case where a detection delay occurs in the lens temperature detecting part 44 when printing has been started immediately after activation (a cold state) of the printer 1.

The controller 50 is connected to an in-equipment temperature detecting part 55 detecting in-equipment temperature inside an equipment (the printer 1) in which the fixing device 18 is installed. On the basis the in-equipment temperature detected by the in-equipment temperature detecting part 55, it is possible to determine whether or not the printer 1 is in a state immediately after the activation (the cold state).

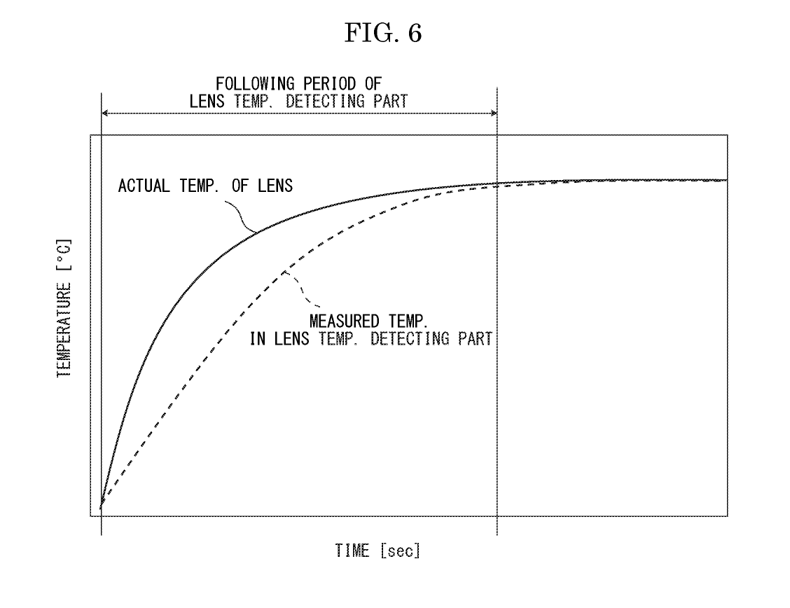

The detection delay of the lens temperature detecting part 44 will be described with reference to FIG. 6. FIG. 6 is a graph showing, on the horizontal axis, an elapsed time from activation of the printer 1, and showing, on the vertical axis, the lens temperature detected by the lens temperature detecting part 44 and the actual temperature of the lens 42. According to FIG. 6, it is found that, if printing is started immediately after the activation of the printer 1, the lens temperature detecting part 44 detecting the temperature of the lens 42 cannot keep track of temperature rise of the lens 42 with respect to the temperature rise of the lens 42 and cannot measure precise temperature of the lens 42. Such a delay is caused by the fact that a time lag occurs because the lens temperature detecting part 44 has a heat capacity. Incidentally, after a predetermined period of time (a tracking period of time, for example, 20 seconds) has elapsed from the activation of the printer 1, the lens temperature detecting part 44 is capable of keeping track of the temperature rise of the lens 42 and is capable of measuring the precise temperature.

Thereupon, the conversion temperature correcting part 54 corrects an electromotive force on the basis of inclination of the electromotive force to a predetermined time unit (for example, 100 milliseconds) detected by the thermopile 40 while the predetermined period of time (the tracking period of time) is elapsed after the printer 1 in the cold state is started, and thereby, corrects the conversion temperature. Such correction of the conversion temperature on the basis of the inclination of the electromotive force will be specifically described hereinafter. Incidentally, during the predetermined period of time (the tracking period of time) for carrying out correction of the conversion temperature on the basis of the inclination of the electromotive force, the above-described correction of the conversion temperature on the basis of the substrate temperature and lens temperature by the conversion temperature correcting part 54 is not carried out.

The conversion temperature correcting part 54 compares, for example, the in-equipment temperature detected by the in-equipment temperature detecting part 55 and the lens temperature detected by the lens temperature detecting part 44 with each other to thereby decide whether or not the printer 1 is in the state immediately after activation (the cold state). The conversion temperature correcting part 54 decides that the printer 1 is in the state immediately after the activation (the cold state), in a case where the in-equipment temperature and the lens temperature are equal (or roughly equal) to each other. At this time, even in a case where there is a difference between the in-equipment temperature and the lens temperature, as long as the difference is in a certain degree of tolerance (in a detection variation range of the sensor of the in-equipment temperature detecting part 55 or the lens temperature detecting part 44), the conversion temperature correcting part 54 may decide that the in-equipment temperature and the lens temperature are equal to each other to decide that the printer 1 is in the state immediately after the activation (the cold state). Incidentally, when the printer 1 starts the activation and the printing, because the heating body 23 is hot in comparison with any other components of the printer 1, the lens temperature of the lens 42 influenced by the temperature rise of the heating body 23 becomes higher in comparison with the in-equipment temperature. That is, the conversion temperature correcting part 54 decides that, if the lens temperature is higher than the in-equipment temperature (for example, higher temperature by 3 degrees centigrade or more), that the printer 1 is not in the state immediately after the activation (the cold state).

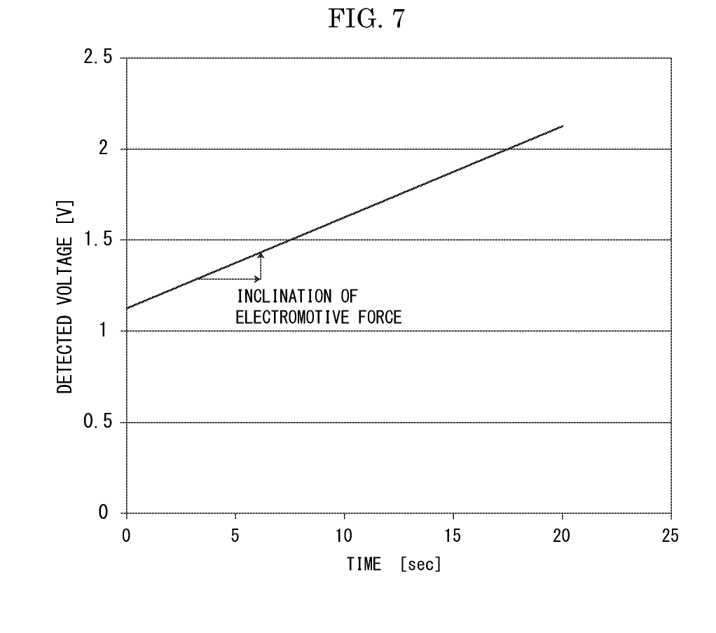

The electromotive force detected by the thermopile 40 will be described with reference to FIG. 7. FIG. 7 is a graph showing, on the horizontal axis, an elapsed time from the activation of the printer 1, and showing, on the vertical axis, the electromotive force detected by the thermopile 40 (a detected voltage). In the thermopile 40, as described above, an electromotive force is generated in the thermocouple 49 due to a temperature difference between the cold contact point 47 and the hot contact point 48. According to FIG. 7, it is found that the electromotive force detected by the thermopile 40 is parallel to a time change. The rapider the inclination of the electromotive force is, the higher the temperature rise of the lens 42 is.

Therefore, the conversion temperature correcting part 54 subtracts an equivalent amount of the inclination of the electromotive force from the electromotive force to thereby correct the temperature rise of the lens 42. For example, the conversion temperature correcting part 54 calculates the inclination of the electromotive force of the thermopile 40 for every predetermined unit time (for example, 100 milliseconds). The conversion temperature correcting part 54 subtracts a multiplication result (a change amount of the detected voltage×α) between the inclination (a change amount of the detected voltage) of the electromotive force and a predetermined second correction coefficient (α) to thereby correct the electromotive force. Incidentally, since the predetermined second correction coefficient is a specific coefficient to each device type of the thermopile 40, the conversion temperature correcting part 54 sets the predetermined second correction coefficient for each device type of the thermopile 40.

In accordance with the embodiment, as described above, the fixing device 18 of the printer 1 (the image forming apparatus) includes the heating body 23, the pressuring body 24, the conversion temperature detecting part 26, the substrate temperature detecting part 43, the lens temperature detecting part 44 and the conversion temperature correcting part 54. In the heating body 23, a surface thereof is heated by the heat source 33. The pressuring body 24 is brought into pressure contact with the heating body 23 to thereby form the fixing nip N. The conversion temperature detecting part 26 is provided with respect to the heating body 23 in a noncontact manner. The conversion temperature detecting part 26 has the thermopile 40 (the infrared ray detecting element) detecting the infrared ray radiated from the surface of the heating body 23, the substrate 38 to which the thermopile 40 is mounted and the lens 42 optically focusing the infrared ray onto the thermopile 40. The conversion temperature detecting part 26 detects the conversion temperature corresponding to the surface temperature of the heating body 23 on the basis of the detection result of the thermopile 40. The substrate temperature detecting part 43 detects the substrate temperature value of the substrate 38. The lens temperature detecting part 44 detects the lens temperature value of the lens 42. The conversion temperature correcting part 54 corrects the conversion temperature on the basis of the substrate temperature value and the lens temperature value. The controller 50 of the fixing device controls the heat source 33 so that the conversion temperature becomes predetermined fixing control temperature.

According to this, even in a case where a temperature difference occurs between the substrate 38 (the environmental temperature sensor 41) of the conversion temperature detecting part 26 and the lens 42 due to rapid temperature rise or the like of the lens 42 and then a gap occurs between the detected temperature by the thermopile 40 and the actually measured temperature, the conversion temperature detecting part 26 corrects the conversion temperature on the basis of the temperature difference. Thus, the conversion temperature detecting part 26 is capable of detecting appropriate conversion temperature equivalent to the surface temperature of the fixing belt 30 of the heating body 23.

In addition, in accordance with the embodiment, the conversion temperature correcting part 54 calculates the difference between the substrate temperature value and the lens temperature value, subtracts the predetermined correction coefficient from the multiplication result between the difference and the predetermined first correction multiplier to thereby calculate the correction value, and then, subtracts the correction value from the conversion temperature to thereby correct the conversion temperature. According to this, the conversion temperature correcting part 54 corrects the conversion temperature of the conversion temperature detecting part so as to eliminate the difference between the lens temperature and the substrate temperature, and therefore, is capable of detecting more appropriate conversion temperature equivalent to the surface temperature of the fixing belt 30 of the heating body 23.

Further, in accordance with the embodiment, the printer 1 (the fixing device 18) further includes the in-equipment temperature detecting part 55 detecting the in-equipment temperature of the equipment (the printer 1) in which the fixing device 18 is installed. The thermopile 40 includes the hot contact point 48 to which an infrared ray is entered and the cold contact point 47 connected to the hot contact point 48 via a plurality of thermocouples 49 and detects, as a detection result, the electromotive force produced due to a temperature difference between the hot contact point 48 and the cold contact point 47. The conversion temperature correcting part 54 calculates the inclination of the electromotive force of the thermopile 40 for the predetermined unit time until the predetermined period of time has elapsed, in a case where the lens temperature and the in-equipment temperature are equal to each other, and then, corrects the electromotive force on the basis of the inclination. According to this, even in a case where the printing is started immediately after the activation of the printer 1 (the cold state) and a detection delay occurs in the lens temperature detecting part 44, it is possible to decide, on the basis of the in-equipment temperature in the in-equipment temperature detecting part 55 and the lens temperature in the lens temperature detecting part 44, whether or not the printer 1 is in the state immediately after the activation (the cold state). In addition, even in a case where a detection delay of the lens temperature detecting part 44 occurs immediately after the activation of the printer 1 (the cold state), by correcting the electromotive force on the basis of the inclination of the electromotive force in the thermopile 40, the conversion temperature detecting part 26 is capable of detecting appropriate conversion temperature equivalent to the surface temperature of the fixing belt 30 of the heating body 23.

Furthermore, in accordance with the embodiment, the conversion temperature correcting part 54 subtracts the multiplication result between the inclination and the predetermined second correction multiplier from the electromotive force detected by the thermopile 40 to thereby correct the electromotive force. According to this, the conversion temperature detecting part 26 is capable of precisely detecting the electromotive force of the thermopile 40 immediately after the activation of the printer 1 (the cold state), and therefore, it is possible to detect more appropriate conversion temperature equivalent to the surface temperature of the fixing belt 30 of the heating body 2 irrespective of the detection delay of the lens temperature detecting part 44.

Although the embodiment was described as to a case in which the heating body 23 is composed of the fixing belt 30, in another embodiment, the heating body 23 may be composed of a heating roller.

The embodiment was described in a case of applying the configuration of the present disclosure to the printer 1. On the other hand, in another embodiment, the configuration of the disclosure may be applied to another image forming apparatus, such as a copying machine, a facsimile or a multifunction peripheral.

While the present disclosure has been described with reference to the particular illustrative embodiments, it is not to be restricted by the embodiments. It is to be appreciated that those skilled in the art can change or modify the embodiments without departing from the scope and spirit of the present disclosure.

What is claimed is:

1. A fixing device comprising:
a heating body, of which a surface is heated by a heat source;
a pressuring body brought into pressure contact with the heating body to form a fixing nip;
a conversion temperature detecting part arranged with respect to the heating body in a noncontact manner, provided with an infrared ray detecting element detecting an infrared ray radiated from the surface of the heating body, a substrate to which the infrared ray detecting element is mounted and a lens optically focusing the infrared ray onto the infrared ray detecting element and configured to detect conversion temperature corresponding to surface temperature of the heating body on the basis of a detection result of the infrared ray detecting element;
a substrate temperature detecting part detecting substrate temperature value of the substrate;
a lens temperature detecting part detecting lens temperature value of the lens;
a conversion temperature correcting part correcting the conversion temperature on the basis of the substrate temperature value and the lens temperature value; and
a controller configured to control the heat source so that the conversion temperature becomes predetermined fixing control temperature.

2. The fixing device according to claim 1, wherein
the conversion temperature correcting part calculates a difference between the substrate temperature value and the lens temperature value, subtracts a predetermined correction coefficient from a multiplication result between the difference and a predetermined first correction multiplier to calculate a correction value and subtracts the correction value from the conversion temperature to correct the conversion temperature.

3. The fixing device according to claim 1, further comprising:
an environmental temperature sensor detecting temperature of the infrared ray detecting element,
wherein the conversion temperature detecting part detects the conversion temperature on the basis of temperature detected by the infrared ray detecting element and temperature detected by the environmental temperature sensor.

4. The fixing device according to claim 1, further comprising:
an in-equipment temperature detecting part detecting in-equipment temperature of an equipment in which the fixing device is installed,
wherein the infrared ray detecting element includes a hot contact point to which the infrared ray is entered and a color contact point connected to the hot contact point via a plurality of thermocouples and detects, as the detection result, a electromotive force generated due to a temperature difference between the hot contact point and the cold contact point,
the conversion temperature correcting part calculates inclination of the electromotive force of the infrared ray detecting element for a predetermined unit time until a predetermined period of time has elapsed, in a case where the lens temperature and the in-equipment temperature are equal to each other, and corrects the electromotive force on the basis of the inclination.

5. The fixing device according to claim 4, wherein
the conversion temperature correcting part subtracts a multiplication result between the inclination and a predetermined second correction multiplier from the electromotive force detected by the infrared ray detecting element to correct the electromotive force.

6. The fixing device according to claim 4, wherein
the conversion temperature correcting part stops correction of the conversion temperature based on the substrate temperature and the lens temperature, during the predetermined period of time.

7. The fixing device according to claim 4, wherein
even in a case where there is a difference between the in-equipment temperature and the lens temperature, as long as the difference is in a detection variation range, the conversion temperature correcting part decides that the lens temperature and the in-equipment temperature are equal to each other.

8. An image forming apparatus comprising the fixing device according to claim 1.

9. An image forming apparatus comprising the fixing device according to claim 2.

10. An image forming apparatus comprising the fixing device according to claim 3.

11. An image forming apparatus comprising the fixing device according to claim 4.

12. An image forming apparatus comprising the fixing device according to claim 5.

13. An image forming apparatus comprising the fixing device according to claim 6.

14. An image forming apparatus comprising the fixing device according to claim 7.
